(19) United States
(12) Patent Application Publication
(10) Pub. No.: US 2021/0222085 A1
(43) Pub. Date: Jul. 22, 2021

(54) DETERGENT COMPOSITION COMPRISING RHAMNOLIPIDS AND/OR MANNOSYLERYTHRITOL LIPIDS

(71) Applicant: BASF SE, Ludwigshafen am Rhein (DE)

(72) Inventors: Frederic BAUER, Ludwigshafen am Rhein (DE); Lukas MAKSYM, Monheim (DE)

(21) Appl. No.: 17/054,847

(22) PCT Filed: Apr. 26, 2019
(86) PCT No.: PCT/EP2019/060739

§ 371 Date: Nov. 12, 2020

(30) Foreign Application Priority Data
May 11, 2018 (EP) 18171774.5

(51) Int. Cl. C11D 1/825; C11D 11/00; C11D 17/06

(52) U.S. Cl. CPC C11D 1/825; C11D 1/662; C11D 17/065; C11D 11/0017

(57) ABSTRACT

The present invention refers to the use of a composition comprising (a) at least one rhamnolipid of the general formula (I) and/or (b) at least one mannosylerythritollipid according to formulae (b1), (b2) and/or (b3) for degreasing greasy and/or oily deposits at temperatures of 40° C. or lower, the use of a dry or liquid formulation comprising said composition as well as the use of said composition as emulsifying agent at temperatures of 40° C. or lower.

### FIELD OF THE INVENTION

The present invention refers to a composition comprising at least one rhamnolipid and/or at least one mannosylerythritol lipid, a dry or liquid formulation comprising said composition as well as the use of said composition as degreasing agent for removing greasy and/or oil type deposits or as emulsifying agent.

### BACKGROUND OF THE INVENTION

Detergent compositions are well known in the art and can be formulated in a number of different ways to address a number of different cleaning problems. For example, such compositions may comprise a great variety of compounds such as builders, optical brighteners, dispersants, enzymes, perfumes, surfactants (anionic, nonionic, cationic and/or amphotheric), soaps, silicon based defoamers, bleaching agents, colorants, dye transfer inhibitors, complexing agents etc., in order to address various problems encountered in cleaning processes. Furthermore, such compositions are typically formulated such that they are effective against the broadest possible spectrum of stains. This need is addressed by providing compositions comprising one or more agent(s) which is/are broadly effective in their cleaning performance.

One particular problem which must be considered and addressed when formulating cleaning compositions is the removal of greasy and oil type deposits such as sebum, oil- and/or fat-containing compositions etc. This problem is even more challenging as the trend in present consumers' behavior goes towards low temperature cleaning operations. That is to say, a sufficient degreasing performance must be achievable at temperatures below 40° C. On the other hand, in industrial washing applications wetting agents are typically used in order to improve the cleaning efficiency at temperatures of far above 40° C. Accordingly, the performance of the compositions and the active compounds contained therein must be achieved over a wide temperature range.

However, compounds or compositions which are known as being sufficient as regards their degreasing behavior at high temperatures typically show a limited degreasing performance at low temperatures and are thus considered unsuitable for such applications.

Therefore, there is a need in the art for providing a compound which avoids the foregoing disadvantages and especially allows for the removal of greasy and/or oil type deposits, especially when used at temperatures of 40° C. Furthermore, it is desirable to provide a compound which allows for the use as emulsifying agent.

Accordingly, it is an object of the present invention to provide a compound or composition that can be used as degreasing agent for the removal of greasy and/or oil type deposits, especially at temperatures of 40° C. or lower. It is another object of the present invention to provide a compound or composition that can be used as emulsifying agent. It is an even further object of the present invention to provide a compound or composition that can be used in cleaning formulations.

### SUMMARY OF THE INVENTION

The foregoing and other objects are solved by the subject-matter of the present invention.

According to a first aspect of the present invention, the use of a composition comprising:
(a) at least one rhamnolipid according to the general formula (I),

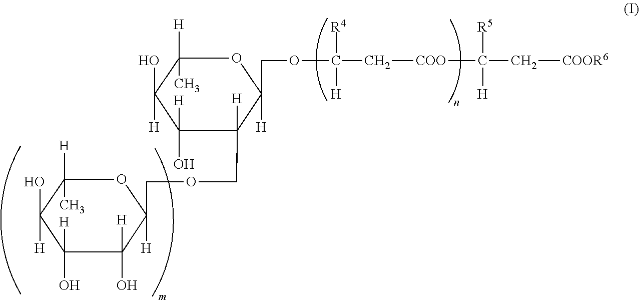

wherein, R⁴ and R⁵ are independently from each other C₂-C₂₄-alkyl; m is an integer in the range of from 0 to 2; n is an integer from 0 to 1; and R⁶ is hydrogen or C₁-C₁₀-alkyl, and/or
(b) at least one mannosylerythritol lipid selected from the group of chemical formulae consisting of (b1), (b2) and (b3) or combinations thereof:
(b1) at least one mannosylerythritol lipid having a 4-O-β-D-mannopyranosyl-meso-erythritol structure according to the general chemical formula (b1):

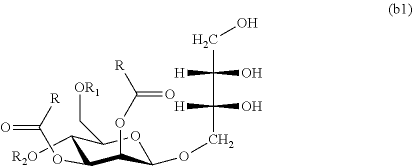

wherein R is alkyl or alkenyl, and R₁ and R₂ independently are H or Ac;
(b2) at least one mannosylerythritol lipid having a 1-O-β-D-mannopyranosyl-meso-erythritol structure according to the general chemical formula (b2):

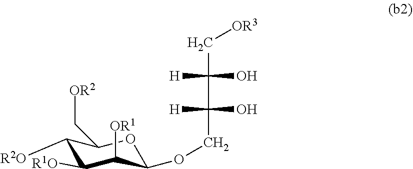

wherein the substituents R₁ may be a same as each other or different from each other and represent fatty series acyl groups having 4-24 carbon atoms, substituents R₂ may be a same as each other or different from each other and represent hydrogen or acetyl groups, and a substituent R₃ represents hydrogen or a fatty series acyl group having 2-24 carbon atoms; and
(b3) a triacylmannosylerythritol lipid according to the following chemical structure (b3):

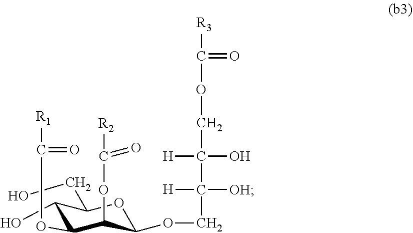

wherein in chemical formula (b3), R₁, R₂, and R₃ independently indicate a carbon hydride group or a carbon hydride group including an oxygen atom,
   for removing greasy and/or oil type deposits at temperatures of 40° C. or lower, is provided.

In a preferred embodiment of the use of a composition of the present invention, for the at least one rhamnolipid in general formula (I), m is 0 or 1.

In another preferred embodiment of the use of a composition of the present invention, for the at least one rhamnolipid in general formula (I), R⁶ is hydrogen or C₁-C₃-alkyl.

In another preferred embodiment of the use of a composition of the present invention, for the at least one rhamnolipid in general formula (I), R⁴ and/or R⁵ is/are independently from each other substituted or unsubstituted C₇-C₂₁-alkyl, more preferably, substituted or unsubstituted C₇, C₉,

C₁₁, C₁₃, C₁₅ or C₁₇-alkyl.

In another preferred embodiment of the use of a composition of the present invention, the at least one rhamnolipid according to the general formula (I) has at least one of the following structures:

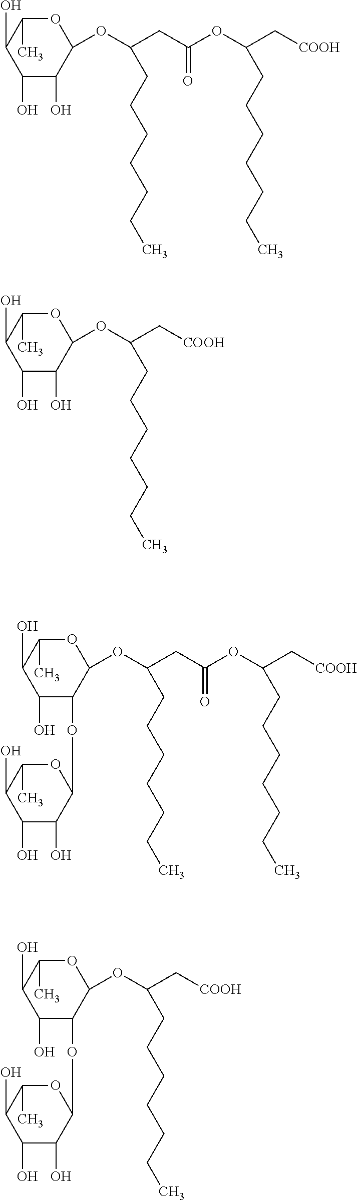

In another preferred embodiment of the use of a composition of the present invention, the at least one rhamnolipid of the general formula (I) is a monovalent sodium or potassium salt of the rhamnolipid of the general formula (I).

In another preferred embodiment of the use of a composition of the present invention, the at least one mannosylerythritol lipid having a 4-O-β-D-mannopyranosyl-meso-erythritol structure according to the general chemical formula (b1) is selected from the group of compounds consisting of:
MEL-A having R₁═R₂═Ac;
MEL-B having R₁═Ac, R₂═H;
MEL-C having R₁═H, R₂═Ac;
MEL-D having R₁═R₂═H; and mixtures thereof.

In another preferred embodiment of the use of a composition of the present invention, the mannosylerythritol lipid structures according to formula (b2) having:
substituents R₁ being fatty series acyl groups having 12 carbon atoms,
substituents R₂ being acetyl groups, and
substituent R₃ being hydrogen are excluded.

In another preferred embodiment of the use of a composition of the present invention, in the mannosylerythritol lipid structures according to formula (b2) one of the substituents R₂ is an acetyl group and the other of the substituents R₂ is hydrogen, and the substituent R₃ is a fatty series acyl group having 2-24 carbon atoms.

In another preferred embodiment of the use of a composition of the present invention, in the mannosylerythritol lipid structures according to formula (b3), R₁, R₂ and R₃ are C₆-C₂₀ alkyl.

In another preferred embodiment of the use of a composition of the present invention, the composition is a dry or liquid formulation.

In another preferred embodiment of the use of a composition of the present invention, the dry or liquid formulation further comprises additives selected from the group comprising anionic surfactants, nonionic surfactants, cationic surfactants, amphoteric surfactants, enzymes, bleaching agents, peroxygen compounds, optical brightener, complexing agents, polymers, e.g. polycarboxylates, soaps, silicon based defoamers, bleaching agents, colorants, dye transfer inhibitors and mixtures thereof.

In another preferred embodiment of the use of a composition of the present invention, the formulation is a single dose formulation or a high concentrated powder formulation having a bulk density of above 600 g/I.

In another preferred embodiment of the use of a composition of the present invention, the temperature is in the range from 5 to 35° C., preferably 15 to 25° C.

According to a second aspect of the present invention, the use of a composition comprising:
a) at least one rhamnolipid according to the general formula (I),

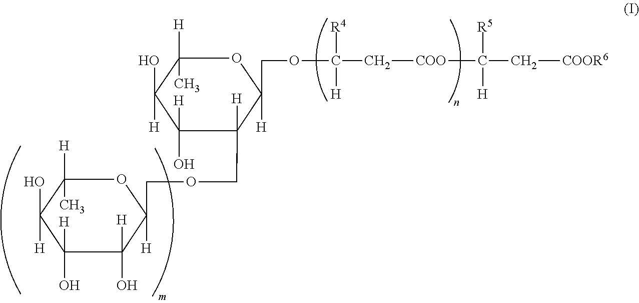

wherein, R⁴ and R⁵ are independently from each other C₂-C₂₄-alkyl; m is an integer in the range of from 0 to 2; n is an integer from 0 to 1; and R⁶ is hydrogen or C₁-C₁₀-alkyl, and/or
(b) at least one mannosylerythritol lipid selected from the group of chemical formulae consisting of (b1), (b2) and (b3) or combinations thereof:
(b1) at least one mannosylerythritol lipid having a 4-O-β-D-mannopyranosyl-meso-erythritol structure according to the general chemical formula (b1):

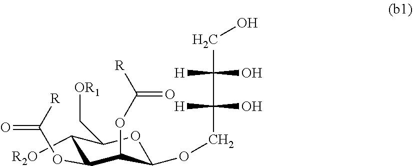

wherein R is alkyl or alkenyl, and R₁ and R₂ independently are H or Ac;
(b2) at least one mannosylerythritol lipid having a 1-O-β-D-mannopyranosyl-meso-erythritol structure according to the general chemical formula (b2):

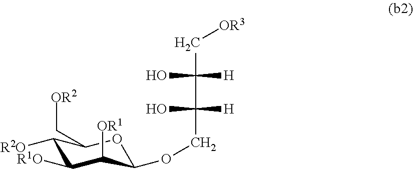

wherein the substituents R₁ may be a same as each other or different from each other and represent fatty series acyl groups having 4-24 carbon atoms, substituents R₂ may be a same as each other or different from each other and represent hydrogen or acetyl groups, and a substituent R₃ represents hydrogen or a fatty series acyl group having 2-24 carbon atoms; and
(b3) a triacylmannosylerythritol lipid according to the following chemical structure (b3):

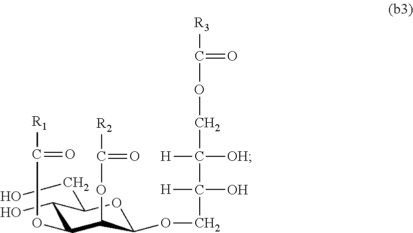

wherein in chemical formula (b3), R₁, R₂, and R₃ independently indicate a carbon hydride group or a carbon hydride group including an oxygen atom, as emulsifying agent at temperatures of 40° C. or lower, wherein the temperature is preferably in the range from 5 to 35° C., more preferably 15 to 25° C., is provided.

In the following, the details and preferred embodiments of the inventive use of the composition comprising the at least one of a rhamnolipid of the general formula (I) will be described in more detail. It is to be understood that these technical details and embodiments also apply to the inventive use of the dry or liquid formulations comprising such composition and their uses.

### DETAILED DESCRIPTION OF THE INVENTION

It was surprisingly found out by the inventors in their studies that the use of a composition comprising:
(a) at least one rhamnolipid according to the general formula (I),

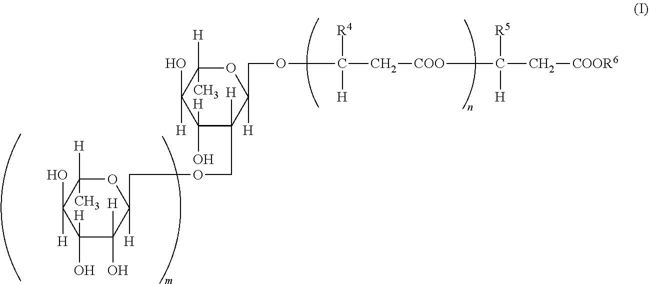

wherein, R⁴ and R⁵ are independently from each other C₂-C₂₄-alkyl; m is an integer in the range of from 0 to 2; n is an integer in the range of 0 to 1; and R⁶ is hydrogen or C₁-C₁₀-alkyl, and/or
(b) at least one mannosylerythritol lipid selected from the group of chemical formulae consisting of (b1), (b2) and (b3) or combinations thereof:
(b1) at least one mannosylerythritol lipid having a 4-O-β-D-mannopyranosyl-meso-erythritol structure according to the general chemical formula (b1):

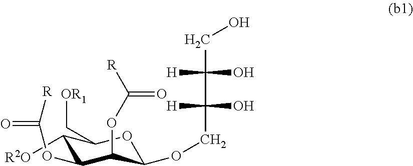

wherein R is alkyl or alkenyl, and R₁ and R₂ independently are H or Ac;
(b2) at least one mannosylerythritol lipid having a 1-O-β-D-mannopyranosyl-meso-erythritol structure according to the general chemical formula (b2):

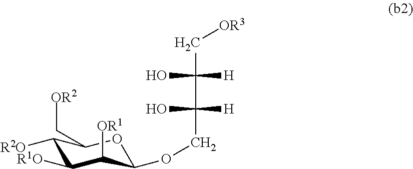

wherein the substituents R₁ may be a same as each other or different from each other and represent fatty series acyl groups having 4-24 carbon atoms, substituents R₂ may be a same as each other or different from each other and represent hydrogen or acetyl groups, and a substituent R₃ represents hydrogen or a fatty series acyl group having 2-24 carbon atoms; and
(b3) a triacylmannosylerythritol lipid according to the following chemical structure (b3):

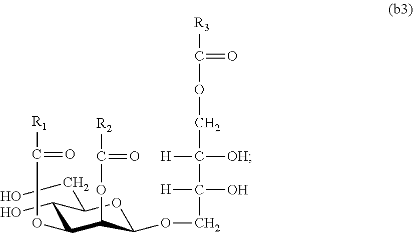

wherein in chemical formula (b3), R₁, R₂, and R₃ independently indicate a carbon hydride group or a carbon hydride group including an oxygen atom, is very suitable for removing greasy and/or oil type deposits at temperatures of 40° C. or lower.

Further, it was surprisingly found by the present inventors that the claimed composition is very suitable for emulsifying and said composition can be used as emulsifying agent, in particular at temperatures of 40° C. or lower.

The at least one rhamnolipid to be used in the composition to be used in the present invention can be prepared by methods well known in the art, For example, the at least one rhamnolipid can be prepared according to the methods described in EP 0 499 434, U.S. Pat. No. 7,985,722, WO 03/006146, JP 60-183032, DE 19648439, DE 19600743, JP 01-304034, CN 1337439, JP 2006-274233, KR 2004033376, JP 2006-083238, JP 2006-070231, WO 03/002700, FR 2740779, DE 2939519, U.S. Pat. No. 7,556,654, FR 2855752, EP 1445302, JP 2008-062179, JP 2007-181789, DE 102012201360A1 and the references cited therein.

The at least one rhamnolipid of the composition to be used in the present invention is preferably a compound of the general formula (I)

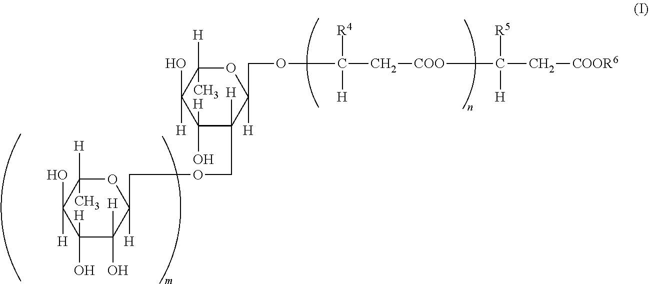

wherein, R⁴ and R⁵ are independently from each other 02-C₂₄-alkyl; m is an integer in the range of from 0 to 2; n is an integer in the range from 0 to 1; and R⁶ is hydrogen or C₁-C₁₀-alkyl.

It is appreciated that R⁴ and R⁵ can be independently from each other C₂-C₂₄-alkyl such as substituted or unsubstituted, linear or branched C₂-C₂₄-alkyl, preferably R⁴ and R⁵ are independently from each other C₇-C₂₁-alkyl such as substituted or unsubstituted C₇-C₂₄-alkyl, more preferably R⁴ and R⁵ are independently from each other C₇-C₁₈-alkyl such as substituted or unsubstituted C₇-C₁₈-alkyl, even more preferably R⁴ and R⁵ are independently from each other C₇-C₁₅-alkyl such as substituted or unsubstituted C₇-C₁₈-alkyl, still more preferably R⁴ and R⁵ are independently from each other C₇-C₁₂-alkyl such as substituted or unsubstituted C₇-C₁₂-alkyl, and most preferably R⁴ and R⁵ are independently from each other C₇-C₉-alkyl such as substituted or unsubstituted C₇-C₉-alkyl. For example, R⁴ and R⁵ are independently from each other C₇, C₉, C₁₁, C₁₃, C₁₅, C₁₇ or C₁₉-alkyl such as linear unsubstituted 07, C₉, C₁₁, C₁₃, C₁₅, C₁₇ or C₁₉-alkyl.

In one embodiment, R⁴ and R⁵ are independently from each other unsubstituted linear C₂-C₂₄-alkyl, preferably R⁴ and R⁵ are independently from each other unsubstituted linear C₇-C₂₁-alkyl, more preferably R⁴ and R⁵ are independently from each other unsubstituted linear C₇-C₁₉-alkyl, even more preferably R⁴ and R⁵ are independently from each other unsubstituted linear C₇-C₁₇-alkyl, still more preferably R⁴ and R⁵ are independently from each other unsubstituted linear C₇-C₁₅-alkyl, and most preferably, R⁴ and R⁵ are independently from each other unsubstituted linear C₇-C₁₃-alkyl. For example, R⁴ and R⁵ are independently from each other unsubstituted C₇, C₉, C₁₁, C₁₃, C₁₅, C₁₇, C₁₉ or C₂₁-alkyl. One very preferred embodiment is defined by R⁴ and R⁵ both being linear and unsubstituted C₇ alkyl. R⁴ and R⁵ are independently from each other C₂-C₂₄-alkyl. That is to say, R⁴ and R⁵ can be the same or different. Preferably, R⁴ and R⁵ are the same.

In the general formula (I), m is an integer in the range of from 0 to 2, preferably m is 0 or 1 and most preferably m is 1. Thus, the rhamnolipid is preferably a mono-, di- or polyrhamnolipid.

In the general formula (I), n is an integer in the range of from 0 to 1, preferably n is 0 or 1 and most preferably n is 1.

In the general formula (I), R⁶ is hydrogen or C₁-C₁₀-alkyl. Preferably, R⁶ is hydrogen or C₁-C₅-alkyl, more preferably R⁶ is hydrogen or C₁-C₅-alkyl, even more preferably R⁶ is hydrogen or C₁-C₃-alkyl and most preferably R⁶ is hydrogen.

It is appreciated that R⁶ can be C₁-C₁₀-alkyl such as substituted or unsubstituted, linear or branched C₁-C₁₀-alkyl, preferably R⁶ is C₁-C₅-alkyl such as substituted or unsubstituted, linear or branched C₁-C₅-alkyl, even more preferably R⁶ is C₁-C₅-alkyl such as substituted or unsubstituted, linear or branched C₁-C₅-alkyl, still more preferably R⁶ is C₁-C₃-alkyl such as substituted or unsubstituted C₁-C₃-alkyl and most preferably R⁶ is C₁- or C₂-alkyl such as substituted or unsubstituted C₁- or C₂-alkyl, e.g. R⁶ is C₁-alkyl such as substituted or unsubstituted C₁-alkyl.

In one embodiment, R⁶ is unsubstituted linear C₁-C₁₀-alkyl, preferably R⁶ is unsubstituted linear C₁-C₅-alkyl, even more preferably R⁶ is unsubstituted linear C₁-C₅-alkyl, still more preferably R⁶ is unsubstituted C₁-C₃-alkyl, and most preferably R⁶ is unsubstituted C₁- or C₂-alkyl, e.g. R⁶ is unsubstituted C₁-alkyl.

Thus, it is especially preferred that the at least one rhamnolipid has the general formula (I),

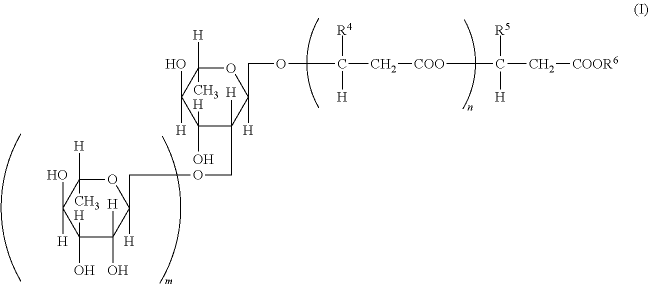

wherein R⁴ and R⁵ are independently from each other C₇-C₂₄-alkyl; m is 0 or 1; n is 0 or 1; and R⁶ is hydrogen or C₁-C₀-alkyl.

More preferably, the at least one rhamnolipid has the general formula (I),

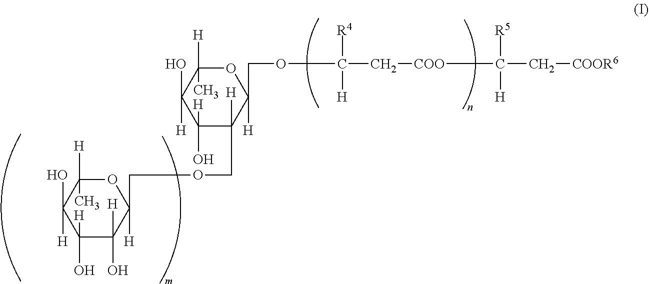

wherein R⁴ and R⁵ are independently from each other C₇-C₂₄-alkyl, preferably C₇-C₂₀-alkyl; m is 0 or 1; n is 0 or 1, and R⁶ is hydrogen.

Most preferably, the at least one rhamnolipid has the general formula (I)

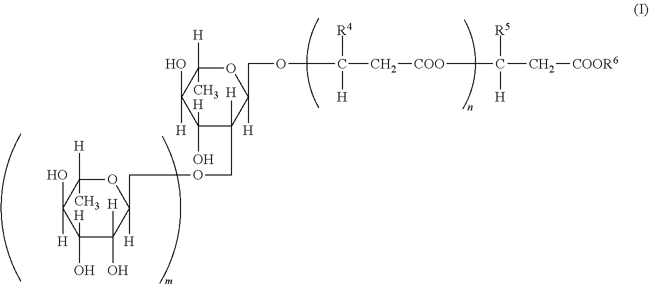

wherein R⁴ and R⁵ are independently from each other C₇-C₅-alkyl, preferably C₇-C₁₁-alkyl; m is 0 or 1; n is 0 or 1, and R⁶ is hydrogen.

If R⁶ is hydrogen, it is appreciated that the at least one rhamnolipid of the general formula (I) can be a monovalent salt, such as a sodium or potassium salt, of the rhamnolipid of the general formula (I).

The at least one mannosylerythritol lipid (MEL) as used in the present invention is already known as a natural surfactant produced by yeast, while it has been previously reported that MEL has various physiological functions. For instance, MEL from natural sources is a material found from Ustilago nuda and Shizonella melanogramma. MEL can also be produced by yeasts such as Candida yeast that is a mutated strain producing itaconic acid, Candida antarctia (currently called as Pseudozyma antarctica) and Kurtzmanomyces yeast. Nowadays, long-time continuous cultivation and production allows producing 300 g/L or more of MEL. Mannosylerytritol lipids are natural amphiphilic components with the same double stranded alkyl as ceramide. The at least one mannosylerythritol lipid (MEL) as used in the present invention includes several isomers and derivatives:

First, conventional mannosylerythritol lipid (MEL) having 4-O-β-D-mannopyranosyl-meso-erythritol structure (b1) is included. Second, a mannosylerythritol lipid (MEL) having 1-O-β-D-mannopyranosyl-meso-erythritol structure, which is an optical isomer of conventional MEL, is also included. Third, triacyl MEL according to chemical formula (b3) is also included in the at least one mannosylerythritol lipid as used in the present invention.

Accordingly, the at least one mannosylerythritol lipid is therefore defined in its broadest meaning as follows:

In one first preferred embodiment, the mannosylerythritol lipid as used in the present invention relates to so-called conventional MEL which is defined as follows:

The conventional MEL is preferably produced through the cultivation of a MEL-producing microorganism. The chemical structure of the conventional MEL is shown by general formula (b1) and is based on 4-O-β-D-mannopyranosyl-meso-erythritol.

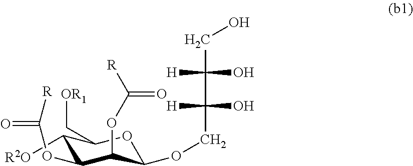

R: alkyl or alkenyl;
MEL-A: R₁═R₂═Ac;
MEL-B: R₁═Ac, R₂═H;
MEL-C: R₁═H, R₂═Ac;
MEL-D: R₁═R²═H;

In the general formula (b1), a substituent R is a hydrocarbon group (alkyl group or alkenyl group). Four kinds of the conventional MEL are known according to whether an acetyl group at 4- and 6-positions of mannose exists or not. The four kinds include MEL-A, MEL-B, MEL-C, and MEL-D.

MEL-A is designed such that each of substituents R₁ and R₂ is an acetyl group in the general formula (b1). MEL-B is designed such that the substituent R₁ is an acetyl group and the substituent R₂ is hydrogen in the general formula (b1). MEL-C is designed such that the substituent R₁ is hydrogen and the substituent R₂ is an acetyl group in the general formula (b1). MEL-D is designed such that each of the substituents R₁ and R₂ is hydrogen.

The number of carbons in the substituent R of the MEL-A, MEL-B, MEL-C, and MEL-D varies according to the number of carbons in fatty acid constituting triglyceride in fats and oils included in an MEL-producing medium and the degree of assimilation of fatty acid by MEL producing microorganism in use. In a case where the triglyceride includes an unsaturated fatty acid residue, when the MEL producing microorganism do not assimilate a double-bonding section of the unsaturated fatty acid, it is possible for MEL to include the unsaturated fatty acid residue as the substituent R. As is evident from the above, each resulting MEL is generally a mixture of compounds having different fatty acid residues of the substituents R. Preferred conventional mannosylerythritol lipids are MEL-A produced, preferably by a fermentation process, using P. antartica, MEL-B produced, preferably by a fermentation process, using P. tsukubaensis, and MEL-C produced, preferably by fermentation using P. hubeiensis.

Accordingly, conventional MEL has a 4-O-β-D-mannopyranosyl-meso-erythritol structure, while the present invention also further includes a modified mannosylerythritol lipid that can be produced by a microorganism leading to a mannosylerythritol skeleton having the molecular structure 1-O-β-D-mannopyranosyl-meso-erythritol. Such isomers and their preparation are in particular described in EP 2 074 985 A2 and are herein included by the second preferred embodiment.

In the second preferred embodiment, the mannosylerythritol lipid as used in the present invention relates to non-conventional MEL, which is based on the following 1-O-β-D-mannopyranosyl-meso-erythritol structure according to the following chemical formula (b2):

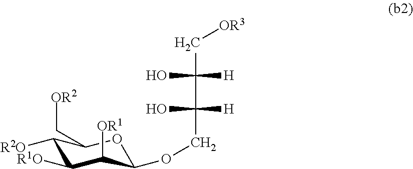

Substituents R₁ may be a same as each other or different from each other and represent fatty series acyl groups having 4-24 carbon atoms, substituents R₂ may be a same as each other or different from each other and represent hydrogen or acetyl groups, and a substituent R₃ represents hydrogen or a fatty series acyl group having 2-24 carbon atoms.

In a third preferred embodiment, the mannosylerythritol lipid (MEL) as used in the present invention also optionally includes a triacyl derivative of MEL. Such triacylated derivatives and their preparation are in particular described in EP 2 074 985. The triacyl derivative of MEL has a different structure with higher hydrophobicity than that of MEL. The triacyl derivative of MEL, i.e. triacylmannosylerythritol lipid (herein referred to as triacyl MEL), relates to the following chemical structure (b3).

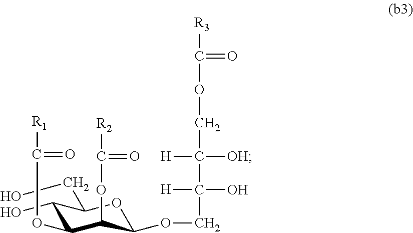

In chemical formula (b3), R₁, R₂, and R₃ independently indicate a carbon hydride group or a carbon hydride group including an oxygen atom. At least one of or both of hydroxyl groups at the 4- and 6-positions of mannose may be replaced with an acetyl group. A carbon hydride group may include only a saturation bond or may include an unsaturation bond. When including an unsaturation bond, the unsaturation bond may include a plurality of double bonds. A carbon chain may be a straight chain or a branched chain. Further, in the case of the carbon hydride group including an oxygen atom, the number and the position of an oxygen atom included in the carbon hydride group are not limited.

In chemical formula (b3), it is preferable that R₁ and R₂ include 6-20 carbon atoms. R₁ and R₂ make, as fatty series acyl groups (RCO—), ester bonds with hydroxyl groups at 2- and 3-positions of mannose. An acetyl group may make ester bond with other hydroxyl group. It is preferable that R₃ has 6-20 carbon atoms. R₃ makes, as a fatty series acyl group (RCO—), ester bond with a primary hydroxyl group of erythritol.

The triacyl derivative of MEL has a structure to which fatty acid ester is added and has high hydrophobicity. Therefore, the triacyl derivative of MEL is excellent as emollient since it is more familiar with various oil components compared with conventional MEL.

The at least one mannosylerythritol lipid as used in the present invention and defined by chemical formulae (b1), (b2) and (b3) may be used either alone or as mixtures.

The at least one mannosylerythritol lipid (MEL) as used in the present invention is prepared and isolated by methods already established in the prior art. Accordingly, in addition to isolation of mannosylerythritol lipids from known natural sources, other suitable methods for preparing the mannosylerythritol lipids as used in the present invention include known fermentation approaches, like those that can be found in EP 2 074 985 A2, WO 2004/020647 A1, WO 2014/185805 A1 and US 2011/0257116 A1.

The use of the composition comprising:
(a) at least one rhamnolipid according to the general formula (I),

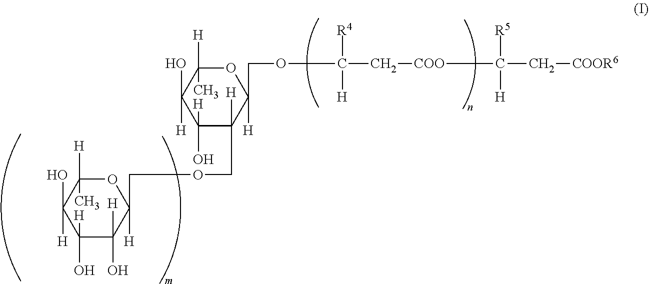

wherein, R⁴ and R⁵ are independently from each other C₂-C₂₄-alkyl; m is an integer in the range of from 0 to 2; n is an integer in the range of 0 to 1; and R⁶ is hydrogen or C₁-C₁₀-alkyl, and/or
(b) at least one mannosylerythritol lipid selected from the group of chemical formulae consisting of (b1), (b2) and (b3) or combinations thereof:
(b1) at least one mannosylerythritol lipid having a 4-O-β-D-mannopyranosyl-meso-erythritol structure according to the general chemical formula (b1):

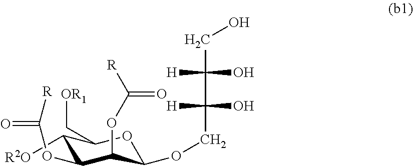

wherein R is alkyl or alkenyl, and R₁ and R₂ independently are H or Ac; (b2) at least one mannosylerythritol lipid having a 1-O-β-D-mannopyranosyl-meso-erythritol structure according to the general chemical formula (b2):

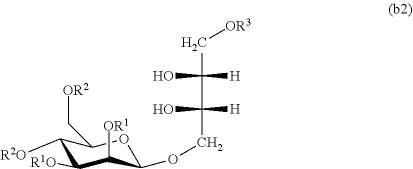

wherein the substituents R₁ may be a same as each other or different from each other and represent fatty series acyl groups having 4-24 carbon atoms, substituents R₂ may be a same as each other or different from each other and represent hydrogen or acetyl groups, and a substituent R₃ represents hydrogen or a fatty series acyl group having 2-24 carbon atoms; and
(b3) a triacylmannosylerythritol lipid according to the following chemical structure (b3):

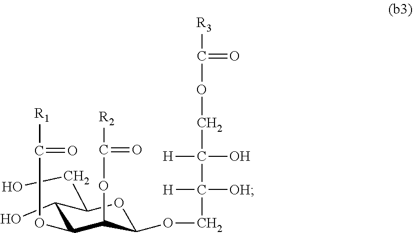

wherein in chemical formula (b3), R₁, R₂, and R₃ independently indicate a carbon hydride group or a carbon hydride group including an oxygen atom, can preferably happen in a dry or liquid formulation.

For example, the dry or liquid formulation to be used in the present invention is a dry or liquid cleaning formulation.

The term “cleaning” is used herein in the broadest sense and means removal of unwanted substances such as oil- and/or fat-containing substances from an object to be cleaned, e.g. fabrics or dishes.

The term “dry formulation” as used herein, refers to formulations that are in a form of a powder, granules or tablets. It is appreciated that the “dry formulation” has a moisture content of 20 wt.-%, more preferably 15 wt.-%, even more preferably 10 wt.-% and most preferably 7.5 wt.-%, based on the total weight of the formulation. If not otherwise indicated, the moisture content is determined according to the Karl Fischer method as outlined in DIN EN 13267:2001. If the dry formulation is provided in form of a powder, the formulation is preferably a high concentrated powder formulation having a bulk density of above 600 g/l.

The term “liquid formulation” as used herein, refers to formulations that are in a form of a “pourable liquid”; “gel” or “paste”.

A “pourable liquid” refers to a liquid formulation having a viscosity of <3 000 mPa·s at 25° C. at a shear rate of 20 sec⁻¹. For example, the pourable liquid has a viscosity in the range of from 200 to 2 000 mPa·s, preferably from 200 to 1 500 mPa·s and most preferably from 200 to 1 000 mPa·s, at 25° C. at a shear rate of 20 sec⁻¹.

A “gel” refers to a transparent or translucent liquid formulation having a viscosity of >2 000 mPa·s at 25° C. at a shear rate of 20 sec⁻¹. For example, the gel has a viscosity in the range of from 2 000 to about 10 000 mPa·s, preferably from 5 000 to 10 000 mPa·s, at a shear rate of 0.1 sec⁻¹.

A “paste” refers to an opaque liquid formulation having a viscosity of greater than about 2 000 mPa·s at 25° C. and a shear rate of 20 sec⁻¹. For example, the paste has a viscosity in the range of from 3 000 to 10 000 mPa·s, preferably from 5 000 to 10 000 mPa·s, at 25° C. at a shear rate of 0.1 sec⁻¹.

Preferably the dry or liquid formulation, more preferably the dry or liquid cleaning formulation, is in form of a liquid formulation. The dry or liquid formulation is preferably in form of a single dose formulation. In one embodiment, the formulation is a high concentrated liquid formulation.

The dry or liquid formulation to be used in the present invention, preferably the dry or liquid cleaning formulation, comprises the composition comprising the at least one rhamnolipid according to the general formula (I) preferably in an amount ranging from 0.1 to 80 wt.-%, preferably from 0.1 to 50 wt.-% and most preferably from 0.1 to 25 wt.-%, based on the total weight of the formulation.

It is appreciated that the dry or liquid formulation to be used in the present invention, preferably the dry or liquid cleaning formulation, may further comprise additives typically used in the kind of formulation to be prepared. For example, the dry or liquid formulation, preferably the dry or liquid cleaning formulation, further comprises additives selected from the group comprising anionic surfactants, nonionic surfactants, cationic surfactants, amphoteric surfactants, enzymes, bleaching agents, peroxygen compounds, optical brightener, complexing agents, polymers, soaps, silicon based defoamers, bleaching agents, colorants, dye transfer inhibitors and mixtures thereof.

Additionally or alternatively, the dry or liquid cleaning formulation to be used in the present invention may optionally comprise a bleach activator as additive. Bleach activators are well known in the art and can be chosen accordingly.

Anionic surfactants suitable for the dry or liquid formulation to be used in the present invention, preferably the dry or liquid cleaning formulation, can be of several different types. For example, the anionic surfactant can be selected from the group comprising alkane sulfonates, olefin sulfonates, fatty acid ester sulfonates, especially methyl ester sulfonates, alkyl phosphonates, alkyl ether phosphonates, sarcosinates, taurates, alkyl ether carboxylates, fatty acid isothionates, sulfosuccinates, C₈-C₂₂ alkyl sulfates, C₈-C₂₂ alkyl alkoxy sulfates, C₁₁-C₁₃ alkyl benzene sulfonate, C₁₂-C₂₀ methyl ester sulfonate, C₁₂-C₁₈ fatty acid soap and mixtures thereof.

Nonionic surfactants suitable for the dry or liquid formulation to be used in the present invention, preferably the dry or liquid cleaning formulation, can be of several different types. For example, the nonionic surfactant can be selected from the group comprising C₈-C₂₂ alkyl ethoxylates, C₆-C₁₂ alkyl phenol alkoxylates, preferably ethoxylates and mixed ethoxy/propoxy, block alkylene oxide condensate of C₆ to C₁₂ alkyl phenols, alkylene oxide condensates of C₈-C₂₂ alkanols and ethylene oxide/propylene oxide block polymers, alkylpolysaccharides, alkyl polyglucoside surfactants, condensation products of C₁₂-C₁₅ alcohols with from 5 to 20 moles of ethylene oxide per mole of alcohol, polyhydroxy fatty acid amides, preferably N-methyl N-1-deoxyglucityl co-coamide or N-methyl N-1-deoxyglucityl oleamide, and mixtures thereof. In one embodiment, the nonionic surfactant may be of the formula R¹(OC2H₄)ₙOH, wherein R¹ is a C₁₀-C₁₆ alkyl group or a C₈-C₁₂ alkyl phenyl group, and wherein n is from 3 to about 80.

Preferred non-ionic surfactants are glucamides, methylesteralkoxylates, alkoxylated alcohols, di- and multiblock copolymers of ethylene oxide and propylene oxide and reaction products of sorbitan with ethylene oxide or propylene oxide, alkyl polyglycosides (APG) in addition to the rhamnolipids according to the present invention, hydroxyalkyl mixed ethers and amine oxides.

Preferred examples of alkoxylated alcohols and alkoxylated fatty alcohols are, for example, compounds of the general formula (III)

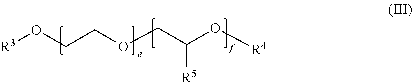

in which the variables are defined as follows:
R³ is selected from C₈-C₂₂-alkyl, branched or linear, for example n-C₈H₁₇, n-C₁H₂₁, n-C₁₂H₂₅, n-C₁₄H₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
R⁵ is identical or different and selected from hydrogen and linear C₁-C₁₀-alkyl, preferably in each case identical and ethyl and particularly preferably hydrogen or methyl,
e and f are in the range from zero to 300, where the sum of e and f is at least one, preferably in the range of from 3 to 50. Preferably, e is in the range from 1 to 100 and f is in the range from 0 to 30.

It is appreciated that e and f may be polymerized randomly or as blocks.

In one embodiment, compounds of the general formula (III) may be block copolymers or random copolymers, preference being given to block copolymers.

Other preferred examples of alkoxylated alcohols are, for example, compounds of the general formula (IV)

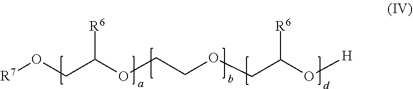

in which the variables are defined as follows:
R⁶ is identical or different and selected from hydrogen and linear C₁-C₁₀-alkyl, preferably identical in each case and ethyl and particularly preferably hydrogen or methyl,
R⁷ is selected from C₆-C₂₀-alkyl, branched or linear, in particular n-C₈H₁₇, n-C₁H₂₁, n-C₁₂H₂₅, n-C₁₃H₂₇, n-C₁₅H₃₁, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a +b+d is preferably in the range of from 5 to 100, even more preferably in the range of from 9 to 50.

Compounds of the general formula (III) and (IV) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (VI) are likewise suitable.

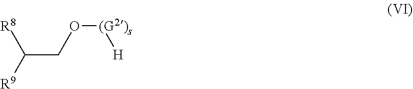

wherein:
R⁸ is C₁-C₄-alkyl, in particular ethyl, n-propyl or isopropyl,
R⁹ is —(CH₂)₂—R⁷,
G² is selected from monosaccharides with 4 to 6 carbon atoms, especially from glucose and xylose,
s in the range of from 1.1 to 4, s being an average number,

Further examples of non-ionic surfactants are compounds of general formula (VII) and (VIII)

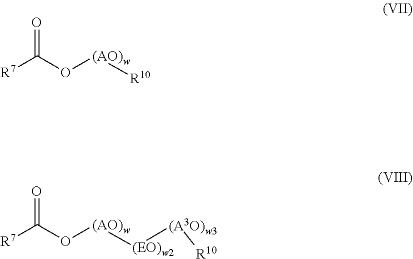

R⁷ is defined as above in general formula (IV).
AO corresponds to the group f as defined above in general formula (II) or the group a or das defined above in general formula (IV).
R¹⁰ selected from C₈-C₁₈-alkyl, branched or linear.
A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DEA 198 19 187 which are incorporated herewith by reference.

Mixtures of two or more different nonionic surfactants selected from the foregoing may also be present.

Cationic surfactants suitable for the dry or liquid formulation, preferably the dry or liquid cleaning formulation, can be of several different types. For example, useful cationic surfactants can be selected from fatty amines, quaternary ammonium surfactants, imidazoline quat materials and mixtures thereof.

Amphoteric surfactants are also suitable optional components in the dry or liquid formulation to be used in the present invention, preferably the dry or liquid cleaning formulation, and can be of several different types. For example, the amphoteric surfactants can be selected from aliphatic derivatives of secondary or tertiary amines and/or aliphatic derivatives of heterocyclic secondary and tertiary amines in which the aliphatic radical can be a straight- or branched-chain. It is preferred that one of the aliphatic substituents contains at least 8 carbon atoms, preferably from 8 to 18 carbon atoms, and at least one contains an anionic water-solubilizing group, e.g., a carboxy, sulfonate or sulfate group.

The present dry or liquid formulation to be used in the present invention, preferably the dry or liquid cleaning formulation, may also comprise enzymes, such as for the removal of protein-based, carbohydrate-based or triglyceride-based stains. For example, suitable enzymes are selected from the group comprising hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, amylases, and mixtures thereof. They may be of any suitable origin, such as vegetable, animal, bacterial, fungal and yeast origin.

In one embodiment, the dry or liquid formulation to be used in the present invention, preferably the dry or liquid cleaning formulation, comprises a mixture of conventional enzymes like protease, lipase, cutinase and/or cellulase in combination with amylase.

Proteases useful herein include those like subtilisins from Bacillus [e.g. subtilis, lentus, licheniformis, amyloliquefaciens (BPN, BPN′), alcalophilus] such as the commercial products Esperase®, Alcalase®, Everlase® or Savinase® available from Novozymes. Commercial products of amylases (α and/or β) are for example available as Purafect Ox Am® from Genencor or Termamyl®, Natalase®, Ban®, Fungamyl® and Duramyl® from Novozymes. Suitable lipases include those produced by Pseudomonas and Chromobacter groups. The lipolase enzymes can be derived from Humicola lanuginosa and are commercially available from Novo or as Lipolase UItra®, Lipoprime® and Lipex® from Novozymes. Also suitable are cutinases and esterases. Suitable cellulases include both bacterial and fungal types, typically having a pH optimum between 5 and 10. Examples include fungal cellulases from Humicola insolens or Humicola strain DSMI 800 or a cellulase 212-producing fungus belonging to the genus Aeromonas, and cellulase extracted from the hepatopancreas of a marine mollusk, Dolabella Auricula Solander. CAREZYME® ENDOLASE and CELLUZYME® of Novozymes or the EGIII cellulases from Trichoderma longibrachiatum are also suitable.

Bleaching enzymes can be used as bleaching agents e.g. peroxidases, laccases, oxygenases, e.g. catechol 1,2 dioxygenase, lipoxygenase, (non-heme) haloperoxidases.

The peroxygen compounds that can be used in the dry or liquid formulation to be used in the present invention, preferably the dry or liquid cleaning formulation, are normally compounds which are capable of yielding hydrogen peroxide in aqueous solution and are well known in the art. For example, the peroxygen compounds can be selected from the group comprising alkali metal peroxides, organic peroxides such as urea peroxide, and inorganic persalts, such as the alkali metal perborate such as sodium perborate tetrahydrate or sodium perborate monohydrate, percarbonates, perphosphates, persilicates, alkylhydroxy peroxides such as cumene hydroperoxide or t-butyl hydroperoxide, organic peroxyacids such as monoperoxy acids (e.g. peroxy-α-naphthoic acid, peroxylauric acid, peroxystearic acid and N,N-phthaloylaminoperoxy caproic acid (PAP), 6-octylamino-6-oxo-peroxyhexanoic acid, 1,12-diperoxydodecanedioic acid (DPDA), 2-decylperoxybutane-1,4-dioic acid or 4,4′-sulphonylbisperoxybenzoic acid) and mixtures thereof.

Optical brighteners include any compound that exhibits fluorescence, including compounds that absorb UV light and reemit as “blue” visible light. In particular, suitable optical brighteners absorb light in the ultraviolet portion of the spectrum between about 275 nm and about 400 nm and emit light in the violet to violet-blue range of the spectrum from about 400 nm to about 500 nm.

For example, the optical brighteners contain an uninterrupted chain of conjugated double bonds. Examples of suitable optical brighteners include derivatives of stilbene or 4,4′-diaminostilbene, biphenyl, five-membered heterocycles such as triazoles, oxazoles, imidiazoles, etc., or six-membered heterocycles (e.g. coumarins, naphthalamide, s-triazine, etc.). Cationic, anionic, nonionic, amphoteric and zwitterionic optical brightener can be optionally present in the dry or liquid formulation to be used in the present invention, preferably the dry or liquid cleaning formulation.

The dry or liquid formulation to be used in the present invention, preferably the dry or liquid cleaning formulation, may also comprise complexing agents, e.g. iron and manganese complexing agents. Such complexing agents can be selected from the group comprising amino carboxylates, amino phosphonates, polyfunctionally-substituted aromatic complexing agents and mixtures thereof. Suitable complexing agents are selected from the alkali metal salts of aminocarboxylic acids and from alkali metal salts of citric acid, tartaric acid and lactic acid. Alkali metal salts are selected from lithium salts, rubidium salts, cesium salts, potassium salts and sodium salts, and combinations of at least two of the foregoing. Potassium salts and combinations from potassium and sodium salts are preferred and sodium salts are even more preferred.

Examples of aminocarboxylic acids are imino disuccinic acid (IDS), ethylene diamine tetraacetic acid (EDTA), nitrilotriacetic acid (NTA), methylglycine diacetic acid (MGDA) and glutamic acid diacetic acid (GLDA).

In one embodiment, formulations to be used in the present invention can contain at least one organic complexing agent (organic cobuilders) such as EDTA (N,N,N′,N′-ethylenediaminetetraacetic acid), NTA (N,N,N-nitrilotriacetic acid), MGDA (2-methylglycine-N,N-diacetic acid), GLDA (glutamic acid N,N-diacetic acid), and phosphonates such as 2-phosphono-1,2,4-butanetricarboxylic acid, aminotri(methylenephosphonic acid), 1-hydroxyethylene(1,1-diphosphonic acid) (HEDP), ethylenediaminetetramethylenephosphonic acid, hexamethylenediaminetetramethylenephosphonic acid and diethylenetriaminepentamethylenephosphonic acid and in each case the respective alkali metal salts, especially the respective sodium salts. Preferred are the sodium salts of HEDP, of GLDA and of MGDA.

The dry or liquid formulation to be used in the present invention, preferably the dry or liquid cleaning formulation, may also comprise polymers, e.g. polycarboxylates.

The dry or liquid formulation to be used in the present invention, preferably the dry or liquid cleaning formulation, preferably comprises one or more of the above additives (in sum) in an amount ranging from 0.5 to 25 wt.-%, preferably from 0.5 to 20 wt.-% and most preferably from 0.5 to 17.5 wt.-%, based on the total weight of the active materials in the formulation. It is to be noted that the total weight of the active materials in the formulation (if not otherwise indicated) refers to the total weight of the one or more additives and the compound of the general formula (I), i.e. without water.

Regarding the use of removing greasy and/or oily deposits, preferred uses of the compositions comprising at least one rhamnolipid of the general formula (i) include removing engine oils, mineral oils, shoe cream, shoe polish, sebum, wool grease, cosmetic stains such as lipstick, solid, pasty or liquid make-up and food stains, especially food stains comprising oil-type components such as plant oils, e.g. olive oil, frying fat, curry oil, soybean oil, soy sauce, chocolate, chocolate mousse, cacao, salad sauce, butter fat, mayonnaise, milk, beef fat, tallow and the like.

The inventors have found in their studies that the use of the composition comprising the at least one rhamnolipid of the general formula (I) for removal of greasy and/or oil type deposits is surprisingly achieved at low temperature operations. Preferred low temperatures at which the claimed degreasing of greasy and/or oily deposits can be reliably achieved is the range from 5 to 40° C., preferably from 15 to 25° C., even more preferably from 18 to 23° C., e.g. at room temperature.

In view of this, the composition comprising the at least one rhamnolipid of the general formula (I) is preferably used as degreasing agent in home care laundry products, industrial laundry products, manual dishwashing, enhanced oil recovery and the like, most preferably home care laundry products.

The use of the composition comprising the at least one rhamnolipid of the general formula (I) as emulsifying agent at temperatures not higher than 40° C. shows excellent results when compared with other emulsifying agents.

It is appreciated that the formed emulsions are stable over time, i.e. no phase separation is recognizable, e.g. for more than 20 min, preferably more than 45 min, more preferably more than 1 hour, even more preferably more than 2 hours, still more preferably more than 3 hours and most preferably more than 4 hours, e.g. from 1 to 10 hours.

Thus, use of the composition comprising the at least one rhamnolipid of the general formula (I) as emulsifying agent is preferably applied in home care laundry products, industrial laundry products, manual dishwashing, enhanced oil recovery and the like.

The scope and interest of the invention will be better understood based on the following examples which are intended to illustrate certain embodiments of the invention and are non-limitative.

### EXAMPLES

In the following experiments, the washing performance was determined by measuring the soiled fabric with the Multi Area Color-measurement Hardware, Mach 5, Testfabrics, Inc., Lab, for determining the ΔR (reflectance) calculated at 460 nm and ΔE calculated between unwashed and washed stain by Mach 5 software. The higher the value, the better is the performance.

### Example 1

The ability of the claimed compositions comprising at least one rhamnolipid according to the general formula (I) and/or at least one mannosylerythritol lipid according to formula (b) to remove greasy and/or oil type deposits at temperatures of 40° C. or lower were studied by using the launder-o-meter in comparison to compositions with a known additive from the prior art (Lutensol AO7).

The washing performance for the selected compositions comprising at least one rhamnolipid according to the general formula (I) and/or at least one mannosylerythritol lipid according to formula (b) was determined in the launder-o-meter as follows:

Several soil swatches were washed together with cotton ballast fabric and 20 steel balls at 20° C. in water in the launder-o-meter with two different commercially available detergent compositions (Ariel® simply and Persil® Universal Megaperls) comprising at least one rhamnolipid according to the formula (I) and/or at least one mannosylerythritol lipid according to formula (b), or, alternatively, a comparative compound as additive. The compositions comprising at least one rhamnolipid and/or mannosylerythritol lipid as tested as well as the corresponding comparative compositions are outlined in Table 1 or Table 2 below. After the washing, the fabrics were rinsed, spin-dried and dried in the air.

TABLE 1
Tested compositions and results for a washing time of 20 min (Ariel ® simply)

| Washing | | Remission after washing expressed as delta E (ΔE) | | | | | | | | |
|---|---|---|---|---|---|---|---|---|---|---|
| formulation | Additive | C-S-10 | C-S-62 | C-S-78 | E-112 | E-141/1 | E-125 | W-20D | C-S-70 | Sum |
| Ariel simply | — | 28.8 | 25.8 | 11.3 | 9.0 | 7.5 | 9.4 | 8.1 | 18.1 | 118.1 |
| Ariel simply | Lutensol | 27.2 | 25.5 | 11.3 | 10.4 | 9.3 | 13.8 | 10.7 | 17.9 | 126.1 |
| | AO7 | | | | | | | | | |
| Ariel simply | RL | 28.3 | 25.3 | 12.6 | 9.8 | 10.0 | 11.4 | 10.4 | 19.3 | 127.2 |
| | R90d90 | | | | | | | | | |
| | di | | | | | | | | | |
| Ariel simply | RL R90 | 29.1 | 28.0 | 13.3 | 10.1 | 10.0 | 12.5 | 11.2 | 17.5 | 131.7 |
| | di | | | | | | | | | |
| Ariel simply | RL mono | 29.0 | 31.6 | 11.9 | 9.2 | 9.5 | 12.4 | 11.3 | 18.9 | 133.7 |

TABLE 2
Tested compositions and results for a washing time of 20 min (Persil ® Universal Megaperls)

| Washing | | Remission after washing expressed as delta E (ΔE) | | | | | | | | |
|---|---|---|---|---|---|---|---|---|---|---|
| formulation | Additive | C-S-10 | C-S-62 | C-S-78 | E-112 | E-141/1 | E-125 | W-20D | C-S-70 | Sum |
| Persil Universal | — | 27.9 | 18.4 | 13.4 | 12.9 | 11.7 | 25.2 | 17.7 | 21.8 | 149.1 |
| Megaperls | | | | | | | | | | |
| Persil Universal | Lutensol | 31.4 | 23.3 | 13.5 | 7.1 | 10.5 | 24.1 | 15.5 | 20.3 | 145.7 |
| Megaperls | AO7 | | | | | | | | | |
| Persil Universal | RL R90d90 | 29.2 | 24.0 | 11.9 | 8.3 | 12.3 | 24.6 | 15.4 | 21.0 | 146.5 |
| Megaperls | di | | | | | | | | | |
| Persil Universal | RL mono | 31.1 | 26.6 | 13.4 | 8.2 | 13.6 | 25.2 | 15.6 | 20.0 | 153.6 |
| Megaperls | | | | | | | | | | |
| Persil Universal | MEL (P. | 31.7 | 25.7 | 13.7 | 10.5 | 12.4 | 26.0 | 15.7 | 20.4 | 156.2 |
| Megaperls | shanxiensis) | | | | | | | | | |
| Persil Universal | MEL (P. | 32.2 | 30.6 | 14.2 | 10.5 | 11.0 | 25.6 | 15.8 | 18.7 | 158.6 |
| Megaperls | aphidis) | | | | | | | | | |

Lutensol ® AO7: C13-C15 oxo alcohol + 7 EO
RL: rhamnolipids obtained from fermentation
RL R90d90: 1:9 composition of L- rhamnosyl-3-hydroxydecanoyl-3-hydroxydecanoat and L- rhamnosylrhamnosyl-3-hydroxydecanoyl-3-hydroxydecanoat; purity 90%
RL R90: 1:4 composition of L- rhamnosyl-3-hydroxydecanoyl-3-hydroxydecanoat and L- rhamnosylrhamnosyl-3-hydroxydecanoyl-3-hydroxydecanoat; purity 90%
RL mono: L- rhamnosyl-3-hydroxydecanoyl-3-hydroxydecanoat
MEL: mannosylerythritol lipid
MEL (P. shanxiensis): 4-O-β-D-mannopyranosyl-(1-4)-D-meso-erythritol; C16:0, C16:1, C16:2 and C14:1
MEL (P. aphidis): 4-O-β-D-mannopyranosyl-(1-4)-D-meso-erythritol; C10:0, C10:1 and C14:1

| | |
|---|---|
| C-S-10 | cotton with butter fat |
| C-S-62 | cotton with lard |
| C-S-78 | cotton with soybean oil |
| E112 | cotton with cacao |
| E-141/1 | cotton with lipstick |
| E-125 | cotton |
| W-20 D | PES cotton with sebum |
| C-S-70 | cotton with chocolate mousse |

The washing conditions are outlined in Table 3 below.

TABLE 3
Washing conditions:

| | |
|---|---|
| Test equipment | Launder-o-meter, LP2 Typ, SDL Atlas Inc., |
| | USA |
| Washing liquor | 250 ml |
| Washing time/temperature | 20 min at 20° C. |
| Dosage | 5 g tested compound/L |
| Fabric/liquor ratio | 1:12.5 |
| Washing cycles | 1 |
| Water hardness | 2.5 mmol/l Ca²⁺:Mg²⁺:HCO₃_{^{−}} 4:1:8 |
| Ballast fabric | 2.5 g cottan fabric 283* + 15 g PN33^{°} fabric; |
| | * supplier: wfk Testgewebe GmbH, Chris- |
| | tenfeld 10, D-41379 Brueggen; |
| | ° knitted polyester, supplier Center for |
| | Testmaterials (CFT) BV, NL-3130 AC |
| | Vlaardingen; |
| Sum ballast + soiled fabric | 20 g |
| Soiled fabric | 1 × 5 cm × 5 cm of each |

From the above results, it can be gathered that the inventive compositions comprising at least one rhamnolipid and/or at least one mannosylerythritol lipid show excellent degreasing capabilities for removing greasy and/or oil type deposits relative to compositions in which the already previously known surfactant was used.

1.-15. (canceled)

16. A composition comprising:
(a) at least one rhamnolipid according to the general formula (I), 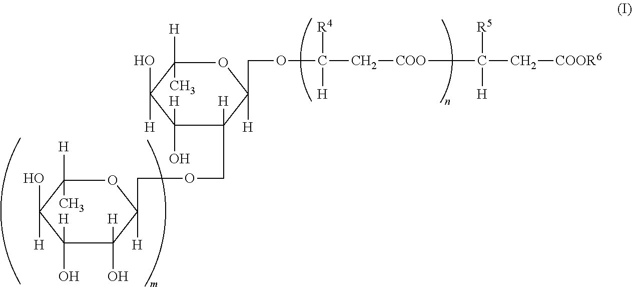
wherein, R⁴ and R⁵ are independently from each other C₂-C₂₄-alkyl; m is an integer in the range of from 0 to 2; n is an integer from 0 to 1; and R⁶ is hydrogen or C₁-C₁₀-alkyl, and/or
(b) at least one mannosylerythritol lipid selected from the group of chemical formulae consisting of (b1), (b2), (b3), and combinations thereof:
(b1) at least one mannosylerythritol lipid having a 4-O-β-D-mannopyranosyl-meso-erythritol structure according to the general chemical formula (b1): 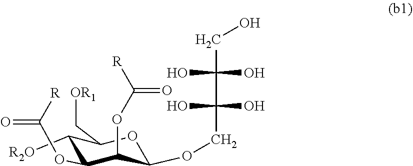
wherein R is alkyl or alkenyl, and R₁ and R₂ independently are H or Ac;
(b2) at least one mannosylerythritol lipid having a 1-O-β-D-mannopyranosyl-meso-erythritol structure according to the general chemical formula (b2): 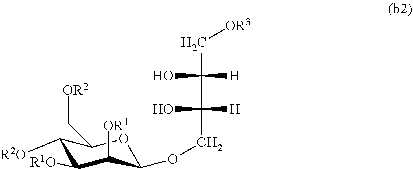
wherein the substituents R₁ may be a same as each other or different from each other and represent fatty series acyl groups having 4-24 carbon atoms, substituents R₂ may be a same as each other or different from each other and represent hydrogen or acetyl groups, and a substituent R₃ represents hydrogen or a fatty series acyl group having 2-24 carbon atoms; and
(b3) a triacylmannosylerythritol lipid according to the following chemical structure (b3): 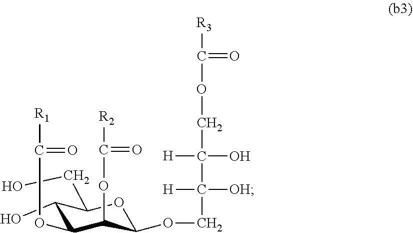
wherein in chemical formula (b3), R₁, R₂, and R₃ independently indicate a carbon hydride group or a carbon hydride group including an oxygen atom,
wherein the composition is a degreasing composition for removing greasy and/or oil type deposits at temperatures of 40° C. or lower.

17. The composition according to claim 16, wherein for the at least one rhamnolipid in general formula (I), m is 0 or 1.

18. The composition according to claim 16, wherein for the at least one rhamnolipid in general formula (I), R⁶ is hydrogen or C₁-C₃-alkyl.

19. The composition according to claim 16, wherein for at least one rhamnolipid in general formula (I), R⁴ and/or R⁵ is/are independently from each other substituted or unsubstituted C₇-C₂₁-alkyl.

20. The composition according to claim 16, wherein the rhamnolipid according to the general formula (I) has at least one of the following structures:

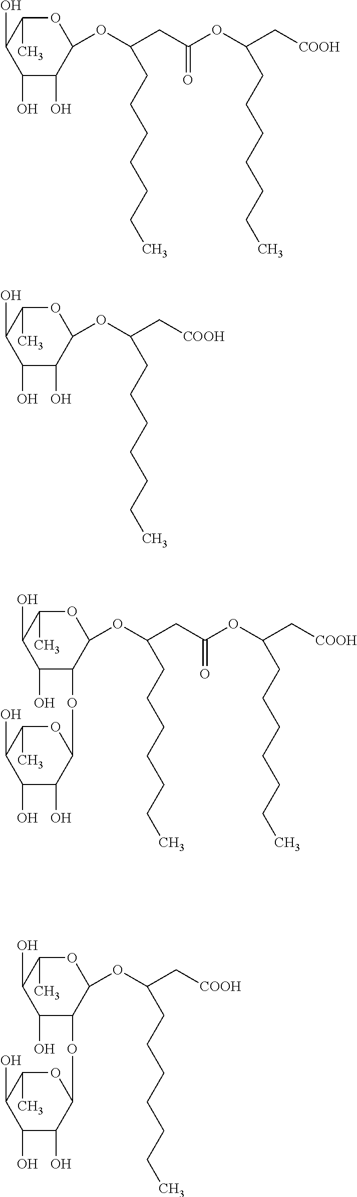

21. The composition according to claim 16, wherein the rhamnolipid of the general formula (I) is a monovalent sodium or potassium salt of the rhamnolipid of the general formula (I).

22. The composition according to claim 16, wherein the at least one mannosylerythritol lipid having a 4-O-β-D-mannopyranosyl-meso-erythritol structure according to the general chemical formula (b1) is selected from the group of compounds consisting of:
MEL-A having R₁═R₂═Ac;
MEL-B having R₁═Ac, R₂═H;
MEL-C having R₁═H, R₂═Ac;
MEL-D having R₁═R₂═H; and mixtures thereof.

23. The composition according to claim 16, wherein the mannosyl erythritol lipid structures according to formula (b2) having:
substituents R₁ being fatty series acyl groups having 12 carbon atoms,
substituents R₂ being acetyl groups, and
substituent R₃ being hydrogen
are excluded.

24. The composition according to claim 16, wherein in the mannosylerythritol lipid structures according to formula (b2) one of the substituents R₂ is an acetyl group and the other of the substituents R₂ is hydrogen, and the substituent R₃ is a fatty series acyl group having 2-24 carbon atoms.

25. The composition according to claim 16, wherein in the mannosylerythritol lipid structures according to formula (b3), R₁, R₂ and R₃ are C₆-C₂₀ alkyl.

26. The composition according to claim 16, wherein the composition is a dry or liquid formulation.

27. The composition according to claim 26, wherein the dry or liquid formulation further comprises additives selected from the group comprising anionic surfactants, non-ionic surfactants, cationic surfactants, amphoteric surfactants, enzymes, bleaching agents, peroxygen compounds, optical brightener, complexing agents, polymers, e.g. polycarboxylates, soaps, silicon based defoamers, bleaching agents, colorants, dye transfer inhibitors and mixtures thereof.

28. The composition according to claim 26, wherein the formulation is a single dose formulation or a high concentrated powder formulation having a bulk density of above 600 g/l.

29. The composition according to claim 16, wherein the temperature is in the range from 5 to 35° C.

30. A composition comprising:
a) at least one rhamnolipid according to the general formula (I), 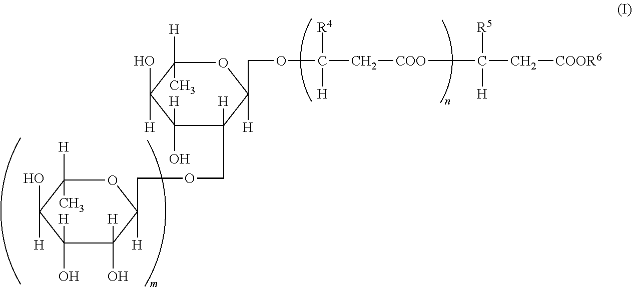
wherein, R⁴ and R⁵ are independently from each other C₂-C₂₄-alkyl; m is an integer in the range of from 0 to 2; n is an integer from 0 to 1; and R⁶ is hydrogen or C₁-C₁₀-alkyl, and/or
b) at least one mannosylerythritol lipid selected from the group of chemical formulae consisting of (b1), (b2) and (b3) or combinations thereof:
(b1) at least one mannosylerythritol lipid having a 4-O-β-D-mannopyranosyl-meso-erythritol structure according to the general chemical formula (b1): 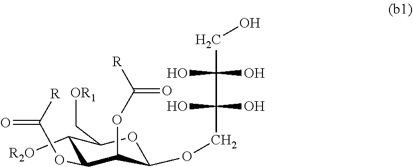
wherein R is alkyl or alkenyl, and R₁ and R₂ independently are H or Ac;
(b2) at least one mannosylerythritol lipid having a 1-O-β-D-mannopyranosyl-meso-erythritol structure according to the general chemical formula (b2): 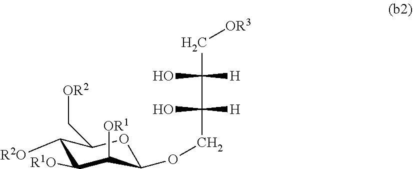
wherein the substituents R₁ may be a same as each other or different from each other and represent fatty series acyl groups having 4-24 carbon atoms, substituents R₂ may be a same as each other or different from each other and represent hydrogen or acetyl groups, and a substituent R₃ represents hydrogen or a fatty series acyl group having 2-24 carbon atoms; and
(b3) a triacylmannosylerythritol lipid according to the following chemical structure (b3): 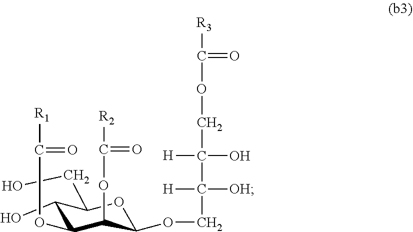
wherein in chemical formula (b3), R₁, R₂, and R₃ independently indicate a carbon hydride group or a carbon hydride group including an oxygen atom, wherein the composition is an emulsifying agent at temperatures of 40° C. or lower.
